(19) United States
(12) Patent Application Publication
(10) Pub. No.: US 2006/0286527 A1
(43) Pub. Date: Dec. 21, 2006

(54) Interactive teaching web application

(76) Inventor: Charles Morel, Naples, FL (US)

Correspondence Address: MACPHERSON KWOK CHEN & HEID LLP, 2033 GATEWAY PLACE, SUITE 400, SAN JOSE, CA, 95110, US

(21) Appl. No.: 11/156,013

(22) Filed: Jun. 16, 2005

(51) Int. Cl. G09B 5/00

(52) U.S. Cl. 434/307 R

(57) ABSTRACT

The invention is an internet based system for developing skills in internet users. The system is a database and application on web servers, communicating over the internet with user client browser applications. The database contains subject texts, associated system and user reference materials. The subject texts are divided into portions, words and phrases, for reference purposes. The system reference materials are text, and media divided into portions corresponding to particular portions of the divided subject text. The user selects a subject text; renders it into a web page, navigates through it, displaying and playing the system reference material dynamically given the particular portion of the subject text.

### BACKGROUND OF THE INVENTION

1. Field of the Invention

The present invention relates to multimedia web applications, and in one instance, to browser-based interactive language learning programs that can show video clips, read-aloud phrases from selected texts, highlight text, and which can annotate these texts with audio notes spoken by the user.

2. Description of the Prior Art

The key to learning a foreign language properly is frequent practice with a native speaker of that language. But private, personal, interactive lessons with a native speaker are expensive when they are available. The traditional, economic way to learn a language has been to attend a class with many other students. But such classes stress the ability of the Instructor to individually interact with each student, and very often fluent native speakers are not available to be the teachers.

Personal computers have, to some extent, allowed students to learn new languages by running language software. These programs vary in quality, and many provide interactive text, audio, and video. The computer, of course, cannot judge the quality of the student's pronunciation.

So-called language laboratory systems relate generally to systems whose object is to train students in hearing and speaking a foreign language in a classroom environment. Such typically comprise a teacher station and a number of student stations connected to the teacher station. Many conventional systems use a tape recorder for storing teaching material and the student's attempts at speech. The teacher station typically allows a teacher to control program sources and student recorders, choose groups and pairs, monitor student activity, contact individual students, group of students, or the whole class. Each student can record their voice to compare it with a model pronunciation and to see progress. More recent language learning systems use electronic digital storage means, e.g., semiconductor memory.

U.S. Pat. No. 5,065,317 describes a language laboratory system wherein a plurality of student training stations are connected to a digital storage device. Headsets in the training stations are connected to the digital storage device. When a control unit receives a record command signal from a training unit, it stores the voice information data in a corresponding partition of the voice memory. The control unit also stores starting and terminating address data.

The United States Defense Language Institute English Language Center uses training systems that allows students to hear a program via a headphone and to respond using the microphone. The student can replay their response. Each student can play back the material and re-record as many times as necessary to perfect the lesson. A computer-based, interactive language laboratory system uses audio cassettes, audio CDs, audio-video cassettes, off-air-broadcasts, video graphics, and CD-ROM multi-media program formats, as well as full-motion, full-screen VGA/SVGA and NTSC, PAL, and SECAM type video signals.

Sun-Tech International Group (Hong Kong, PRC) markets Digital Language Laboratory (DLL) Software to help students practice, articulate and excel at language skills. DLL is described in their advertising as a four-in-one (audio+video+text+exam) multimedia language laboratory software system. The combination of pronunciation practice, video presentation, audio discussion and exercises is used to create an interactive teaching and learning environment. Sun-Tech says there is no need for hardware devices. DLL provides all functions that existing hardware systems have, plus a set of unique advanced feature.

The United States Department of Education and the Chinese Ministry of Education jointly proposed a web-based language learning system in September 2002. See, “The E-Language Learning Project: Conceptualizing a Web-Based Language Learning System”, a white paper prepared for the first meeting of the Technical Working Group of the Sino-American E-Language Project, written by Yong Zhao, Michigan State University, September 2002. Such proposed a system intended to be used by school students 11-18 years old. The system would be deliverable on CD-ROM and over the Internet to enable all students regardless of network access. The four major functional components of the system are described as delivery, communication, feedback, and management. The programmed content is supplemented by live content, e.g., printed news clips, TV programs, and even live chats with local and remote instructors.

### SUMMARY OF THE INVENTION

Briefly, in a particular instance, a business system embodiment of the present invention uses the Internet to develop language skills in subscribing students. An institution presents an Internet host to the Internet using a web server. Such facilitate the internet presence of and communication with business clients, students, administrators, and informational sources. A language learning system application software implements the teaching environment from the server. It uses a raw database made of external sources, and processes such into a rendered database. The raw database includes audio, video, and still media. Users at client sites can annotate with audio and text markup. Other external sources of information, teaching materials, and media are collected in the raw database for later processing. A work preparation process converts the raw source materials into subject works, e.g., subject and reference text, and audio, video, and still-image media. These are stored in the rendered database. The language learning system allows client/student browsers to subscribe and log-on. The server maintains subscription account management, user profiles, and databases of instructional material.

An advantage of the present invention is that an interactive learning system is provided that is effective in helping students learn new subjects.

A further advantage of the present invention is that a language learning system is provided that is effective in helping students learn new languages.

Another advantage of the present invention is that a language teaching environment is provided that allows close personal interaction.

A further advantage of the present invention is that a school business system is provided that produces increased sales and profits over simple in-person classrooms.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a functional block diagram of a business system embodiment of the present invention;

FIG. 2 is a flowchart of the informational sources gathered and rendered to a database in the server in FIG. 1;

FIG. 3 is a diagram showing how the file storage at the server flows through the Internet to individual clients and appears at specific portions of a browser window;

FIG. 4 is a flowchart of a session life cycle a client user would invoke while logged onto the server in FIG. 1;

FIG. 5 is a top level flowchart of a user interaction process a client user would invoke while logged onto the server in FIG. 1;

FIG. 6 is a flowchart of a content unselected process a client user would invoke while logged onto the server in FIG. 1;

FIG. 7 is a flowchart of a text selection process a client user would invoke while logged onto the server in FIG. 1;

FIG. 8 is a flowchart of a markup selection process a client user would invoke while logged onto the server in FIG. 1;

FIG. 9 is a flowchart of a chapter heading selection process a client user would invoke while logged onto the server in FIG. 1;

FIG. 10 is a flowchart of a markup action process a client user would invoke while logged onto the server in FIG. 1;

FIG. 11 is a flowchart of a notation action process a client user would invoke while logged onto the server in FIG. 1;

FIG. 12 is a flowchart of a mouseover note markup process a client user would invoke while logged onto the server in FIG. 1;

FIG. 13 is a flowchart of a note entry/edit process a client user would invoke while logged onto the server in FIG. 1;

FIG. 14 is a flowchart of a highlight context process a client user would invoke while logged onto the server in FIG. 1;

FIG. 15 is a flowchart of a highlight process a client user would invoke while logged onto the server in FIG. 1;

FIG. 16 is a flowchart of a lookup content process a client user would invoke while logged onto the server in FIG. 1;

FIGS. 17A and 17B are flowcharts of an audio note process a client user would invoke while logged onto the server in FIG. 1; and

FIG. 18 is a flowchart of a play media process and an included pause/resume media process a client user would invoke while logged onto the server in FIG. 1.

### DETAILED DESCRIPTION OF THE PREFERRED EMBODIMENT

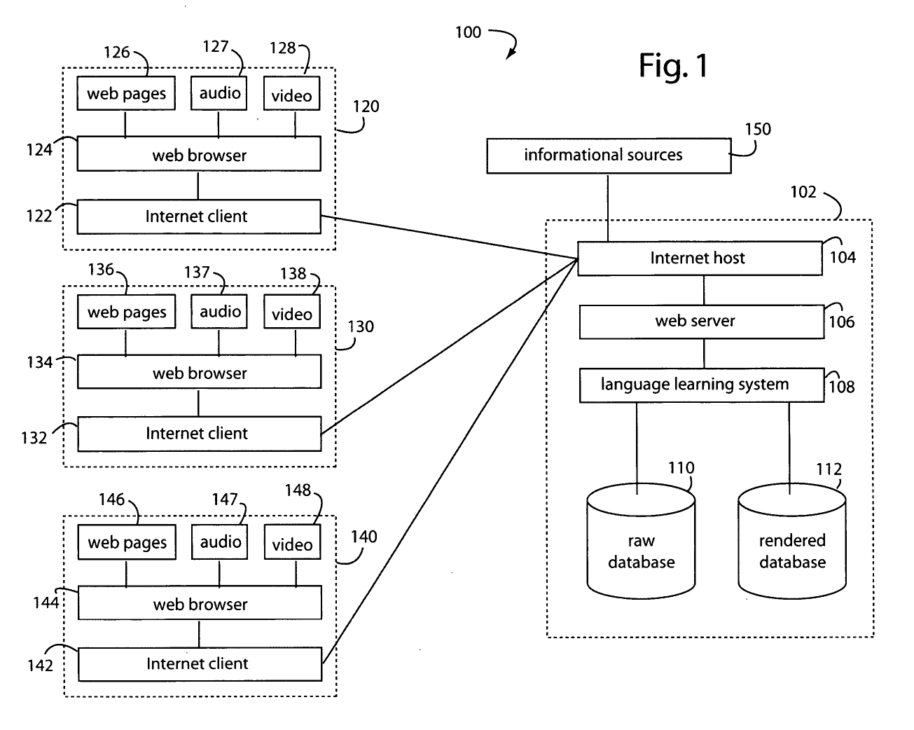

FIG. 1 represents a business system embodiment of the present invention, and is referred to herein by the general reference numeral 100. Such system 100 uses the Internet to develop skills in subscribing students, e.g., to learn new languages. An institution 102 presents an Internet host 104 to the Internet using a web server 106. Such facilitate the internet presence of and communication with business clients, students, administrators, and informational sources. A language learning system 108 is an application software that implements the teaching environment. It uses a raw database 110 made of external sources, and processes these for a rendered database 112. The raw database 110 includes audio, video, and still media. Users at client sites can contribute audio and text markup annotations. Other external sources of information, teaching materials, and media are collected in the raw database 110 for later processing. A work preparation process converts the raw source materials into subject works, e.g., subject and reference text, and audio, video, and still-image media. These are stored in the rendered database 112.

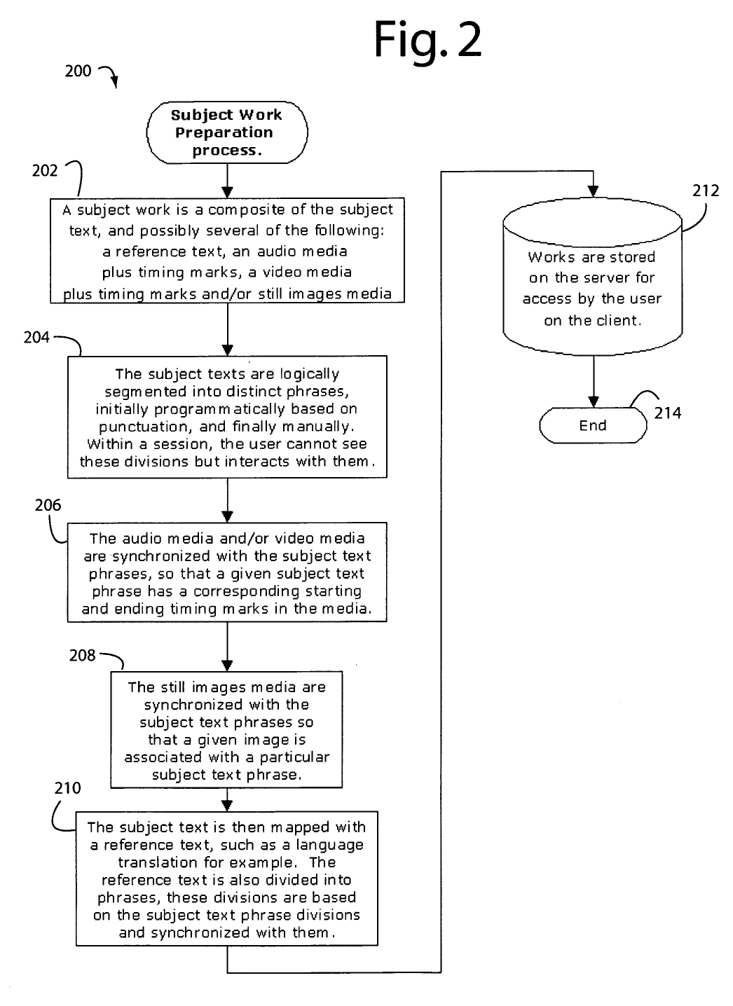

FIG. 2 represents an offline subject work preparation process 200. A subject work is defined in a step 202 as including selections from reference texts, audio and/or video media with timing marks, still images, and other media. A step 204 segments the subject texts into distinct phrases. The partitioning is invisible to the user. A step 206 synchronizes the audio and/or video media with the video according to embedded timing marks. A step 208 synchronizes the still images with corresponding subject text phrases. A step 210 maps the subject text with reference text, e.g., a language translation. The reference text is divided into phrases. These processed works are stored in a step 212 on the rendered database 112 (FIG. 1). A step 214 ends the process and returns to the calling program.

Audio and video media files are processed to include media timing marks that associate segments of the media, delineated by time, with subject text phrases. When a user enrolls as a member they specify their native language and language of study in a profile. The lookup text is what a user specifies to be researched or looked up. A notation frame is part of the users display that includes a list of the user's markup that has occurred in the subject frame. Note text is entered and associated with a phrase in the subject frame as part of a markup. Highlighting, text and special characters are used to distinguish and facilitate the user's interactions in a subject frame. Media timing marks time-delineate points within the media that associate a media point with subject text phrases.

A prompt dialog window facilitates keyboard input by the user, where text could be entered. Raw audio media files do originally include media timing marks. A particular reading list is made available to a particular user given their language and works profile. Reference texts are associated with a subject text displayed in a subject frame.

A subject frame part of a window displayed to the user includes the subject text. The principal document for the subject work permits navigation to audio, video, still media, and reference texts. The subject work is the composition of the associated subject text, reference text, and the audio, video and still media. A target phrase is currently selected by the user in the subject text, within the subject frame. Each user has identified themselves to the facility as having a particular language and work profile. Video files contain media timing marks that associate segments, delineated by time, with subject text phrases.

FIG. 1 illustrates three typical student-clients, many more are possible and any one of these clients could be used by a teacher, guest lecturer, network administrator, etc. A first student-client 120 is implemented with an Internet client 122 that can communicate over the Internet with the Internet host 104. Such host could require a paid subscription before allowing access and use of the language learning system 108. The student-client 120 further includes a standard web browser 124 which can present interactive web pages 126, audio input/output 127, and video input/output 128. A second student-client 130 is implemented with an Internet client 132. The second student-client 130 further includes a standard web browser 134 which can present to a second student an individualized set of interactive web pages 136, audio input/output 137, and video input/output 138. A third student-client 140 is implemented with an Internet client 142. The third student-client 140 further includes a standard web browser 144 which can present to a third student a customized set of interactive web pages 146, audio input/output 147, and video input/output 148. An informational sources 150 represents all the possible external sources of information, data, and any kind of media.

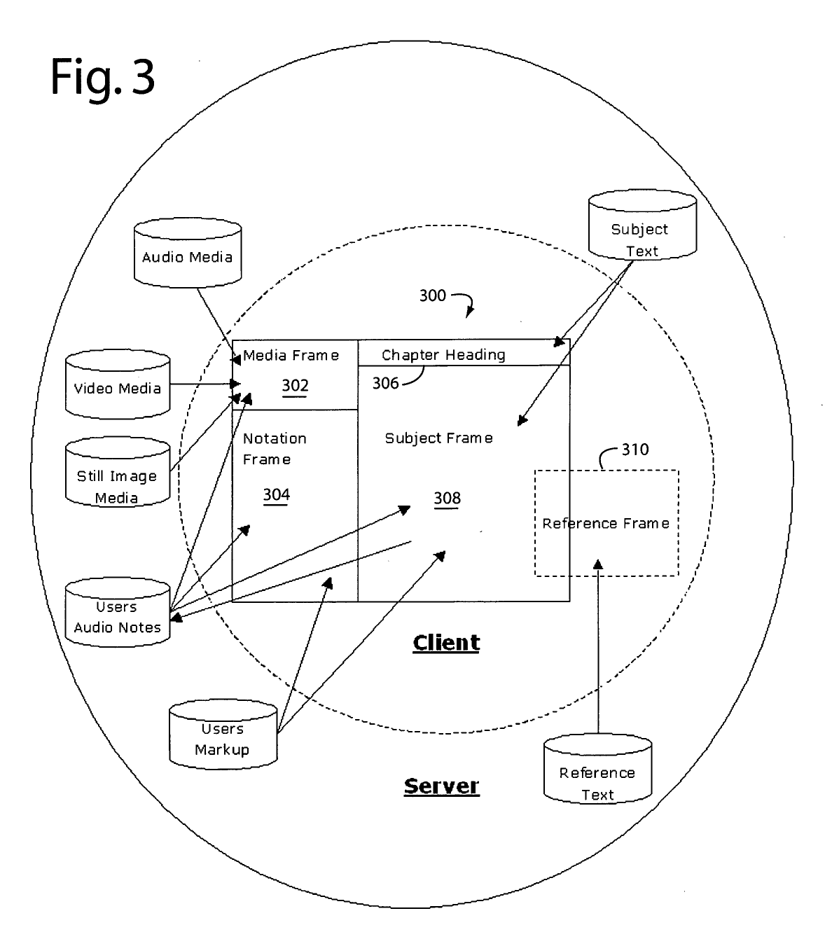

FIG. 3 represents a screen presentation that is typically displayed by a browser at a client site, e.g., browsers 124, 134, and 144. A window 300 is partitioned into a media frame 302, a notation frame 304, a chapter heading 306, and a subject frame 308. A reference frame 310 overlaps and is refreshed from a reference text source. The other text, media, notes, and markups are stored in the rendered database and communicated over the Internet to the clients as-needed.

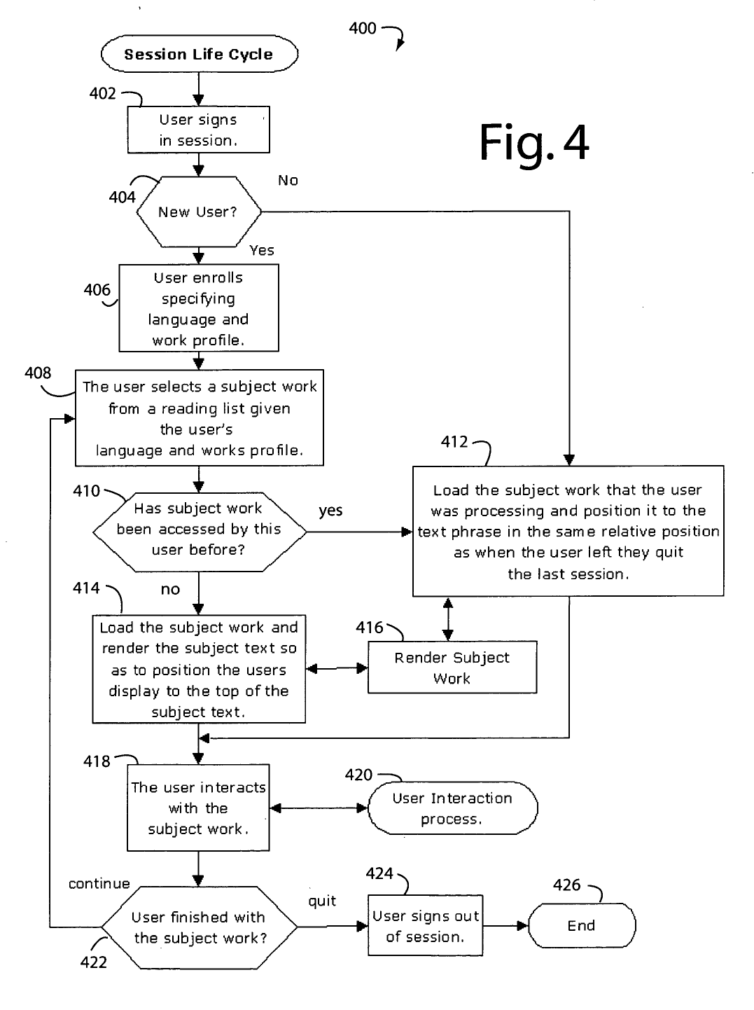

FIG. 4 represents a client session lifecycle 400 executed by language learning system 108 (FIG. 1). The client session lifecycle process 400 is used each time a client begins a new interactive session with language learning system 108. A user signs-in with a log-in step 402. A step 404 determines if this is a first-time user. If yes, a step 406 asks the new user to enroll by specifying their native language and the language that they will be studying. A work profile is generated. A step 408 allows new and existing users to select a subject work from a suggested reading list. The users' languages and work profile are referenced to make such suggestions. A step 410 checks to see if the subject works have been accessed before. If no, a step 412 fetches the subject work from the rendered database 112 (FIG. 1) and sends it to the respective browser. The subject work is positioned as it was when this user last left it. Otherwise, a step 414 loads the subject work to the raw database 110 (FIG. 1), renders it in a step 416, stores it in the rendered database 112 (FIG. 1), and sends it to the respective browser. In a step 418, the user interacts with the subject work, and a user interaction process subroutine 420 is called. A step 422 sees if the user is finished, and if not returns to step 408. Otherwise, a step 424 allows the user to sign-out and the session 400 ends with a step 426.

The text and media to be used in online processes can be prepared offline. The offline preparation should be completed before the online processes will need them.

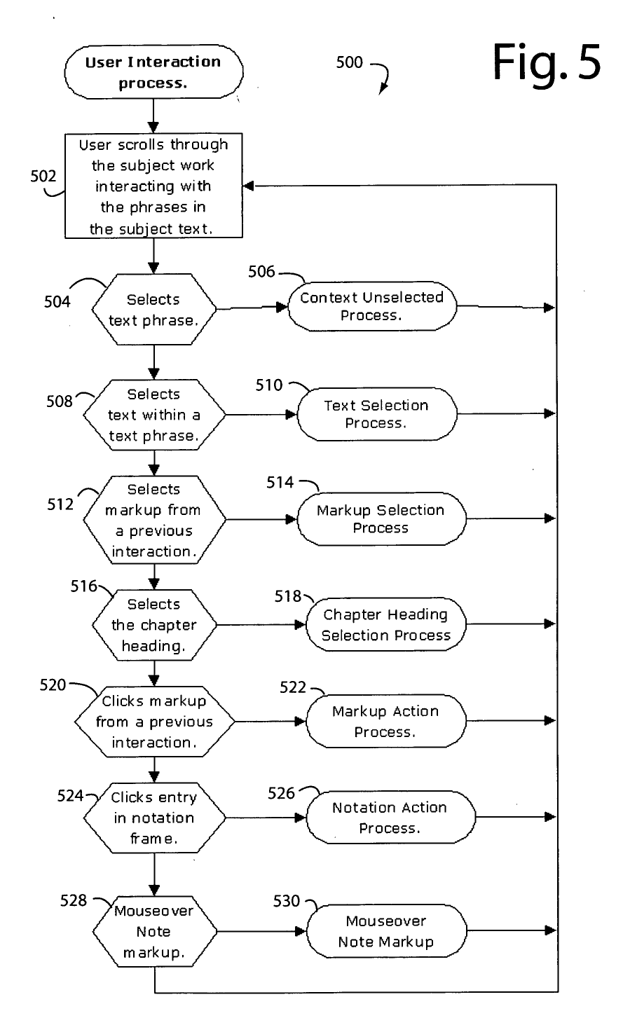

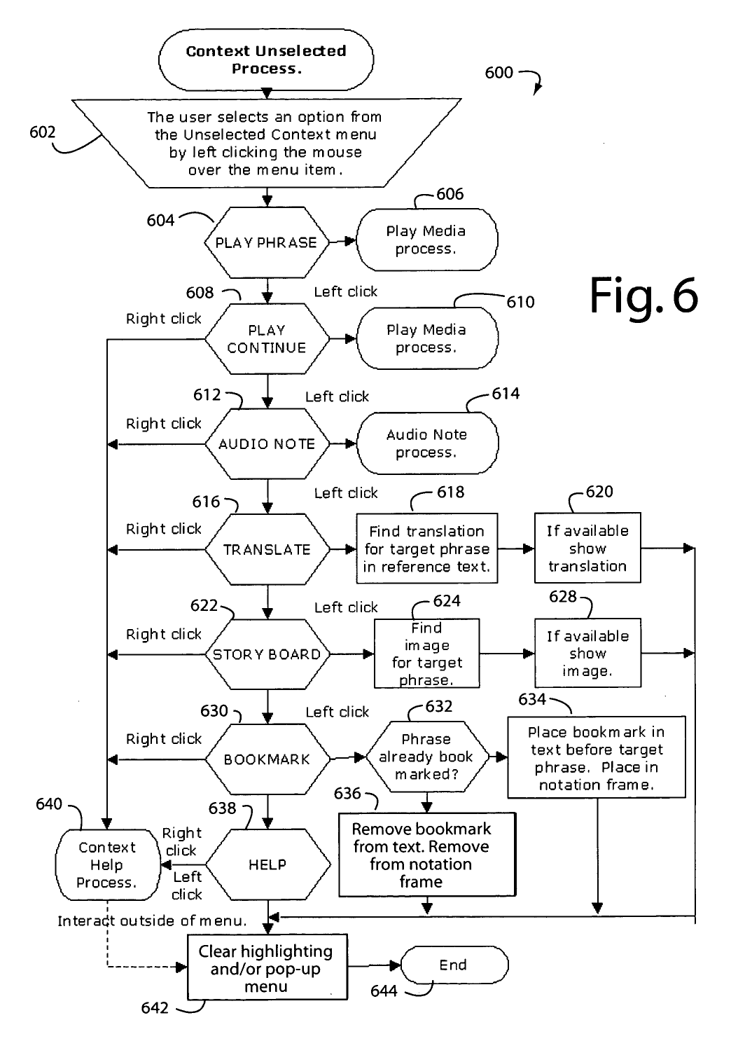

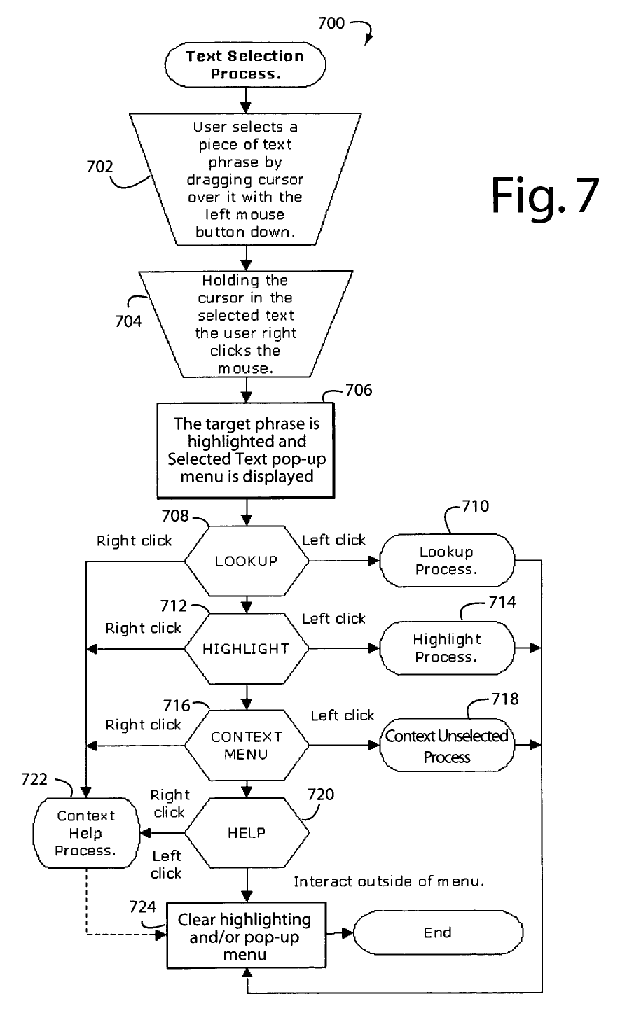

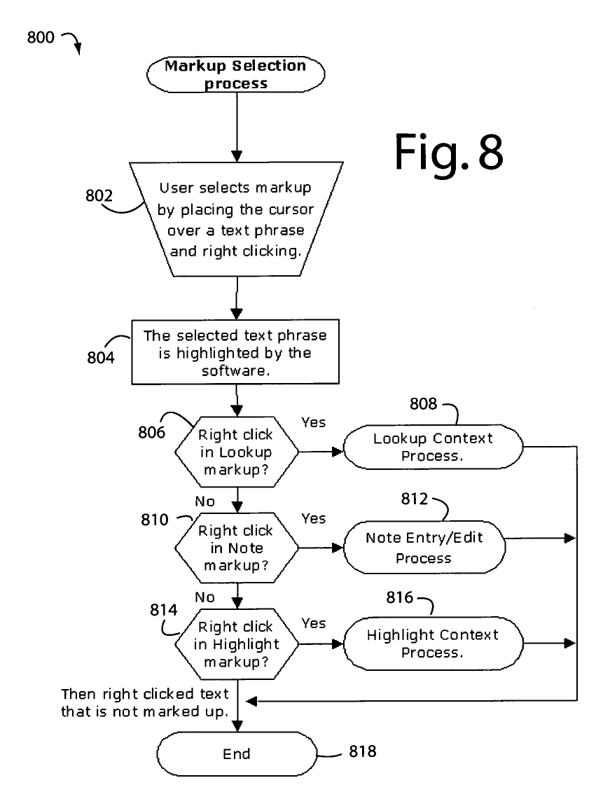

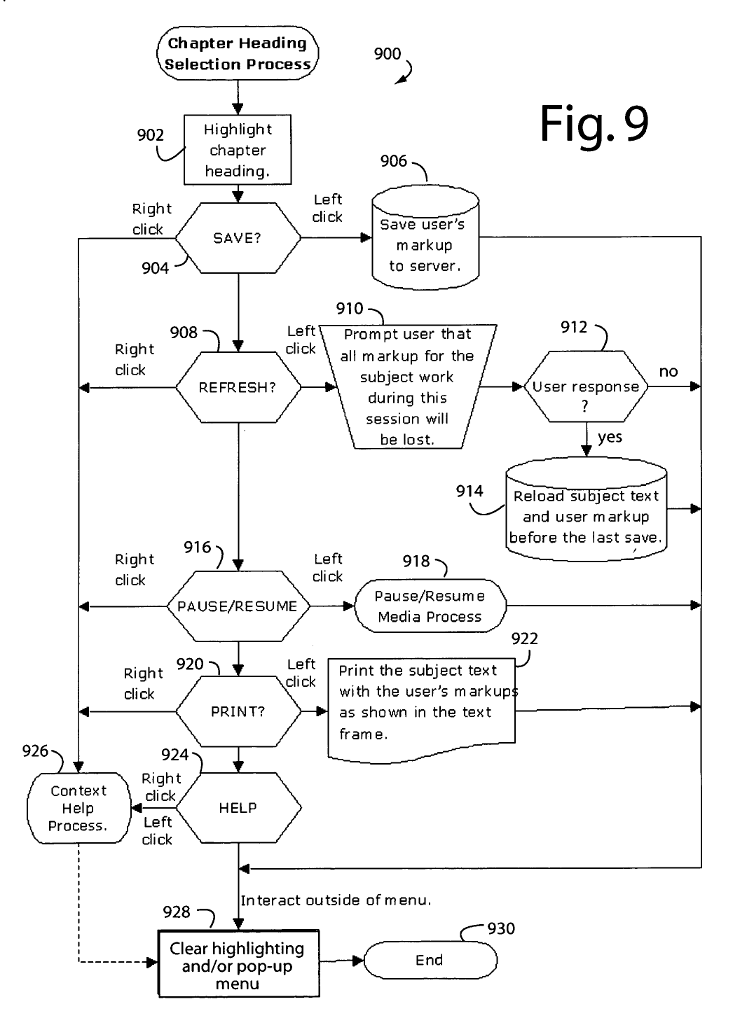

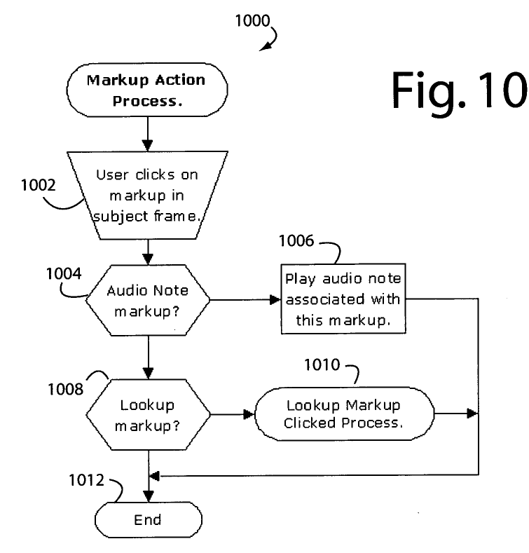

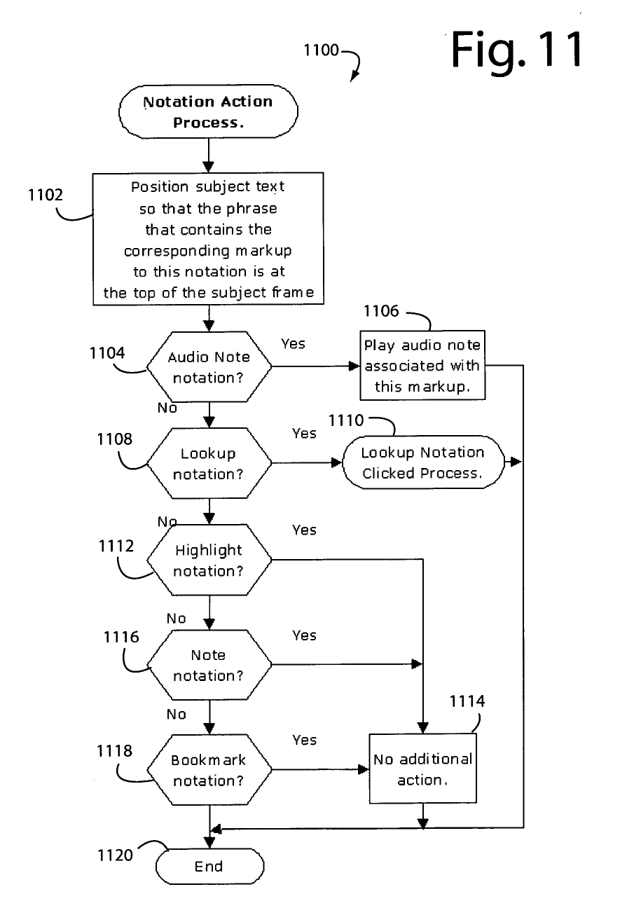

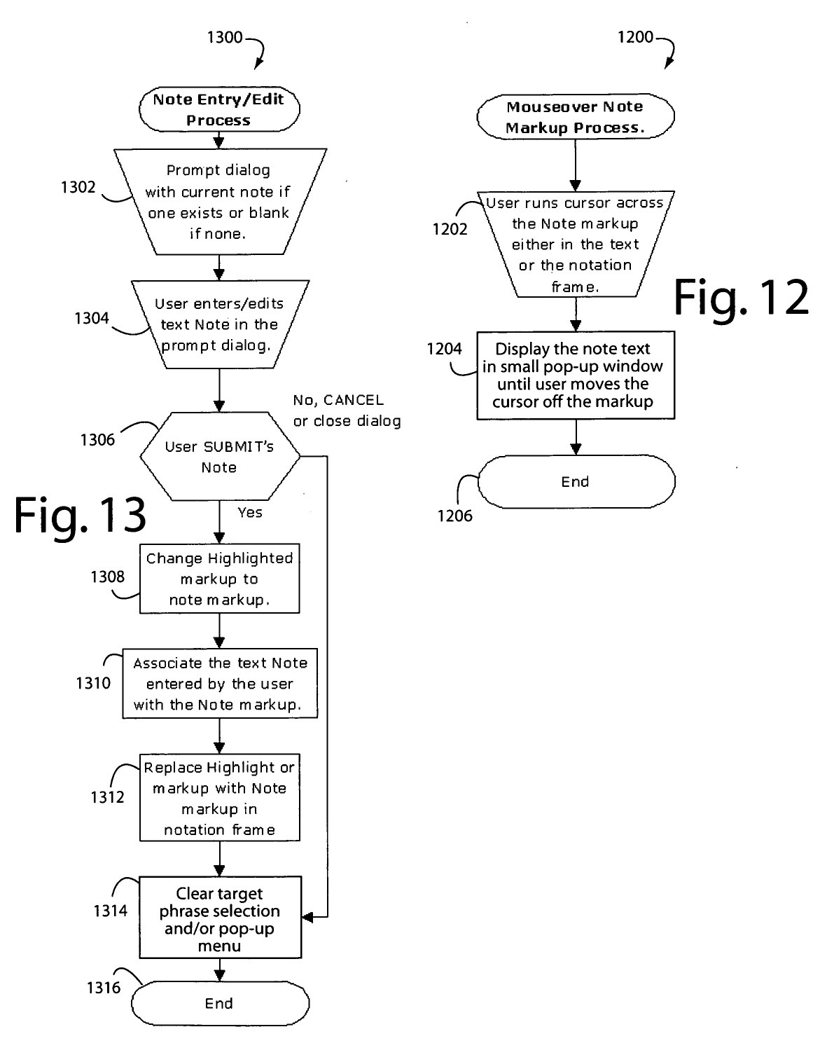

FIG. 5 represents a user interaction process 500 that is executed by the language learning system 108 (FIG. 1) through the respective browser in the client. The user interaction process 500 begins with a step 502 that allows the user to scroll through the subject work. The user can interact with phrases within the subject text. If the user selects a text phrase with the mouse, a step 504 calls a context unselected process 506 (see process 600, FIG. 6). Otherwise, if the user selects a text within a phrase with the mouse, a step 508 calls a context selection process 510 (see process 700, FIG. 7). Otherwise, if the user selects a markup with the mouse, a step 512 calls a markup selection process 514 (see process 800, FIG. 8). Otherwise, if the user selects a chapter heading with the mouse, a step 516 calls a chapter heading selection process 518 (see process 900, FIG. 9). Otherwise, if the user selects a markup from a previous interaction, a step 520 calls a markup action process 522 (see process 1000, FIG. 10). Otherwise, if the user right-clicks an entry in the notation frame 304 (FIG. 3), a step 524 calls a notation action process 526 (see process 1100, FIG. 11). A step 528 detects a mouseover note markup to call a step 530 mouseover note markup process (see process 1200, FIG. 12).

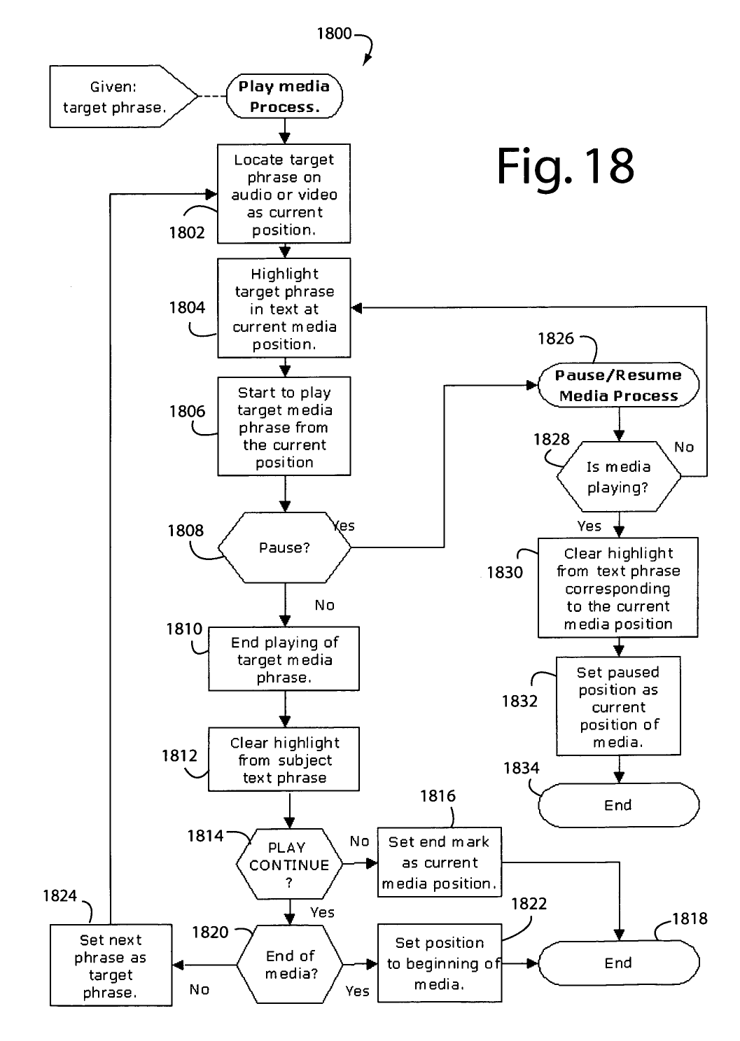

FIG. 6 represents a context unselected process 600, (see step 506, FIG. 5). A step 602 allows the user to select an option from the Unselected Context menu by clicking the mouse over the respective item. If the mouse is clicked on a “play phrase” menu item, a step 604 detects this and calls a play media process step 606 (see process 1800, FIG. 18). If the mouse is left-clicked on a “play continue” menu item, a step 608 detects this and calls a play media process step 610 (see process 1800, FIG. 18). If the mouse is left-clicked on an “audio note” menu item, a step 612 detects this and calls an audio note process step 614. If the mouse is left-clicked on an “translate” menu item, a step 616 detects this and calls a find translation step 618. If a translation is available, a step 620 shows it. If the mouse is left-clicked on a “storyboard” menu item, a step 622 detects this and calls a find image step 624. If an image is available, a step 628 shows it. If the mouse is left-clicked on a “bookmark” menu item, a step 630 detects this and calls a step 632. Such checks to see if the phrase is already bookmarked. If not, a step 634 places a bookmark in the text in front of the target phrase and such is put in the notation frame. Otherwise, a step 636 removes the bookmark from the text and notation frame. Any click of a “help” menu item will be detected by a step 638 and a context help process 640 will be called. A step 642 clears any remaining highlighting and outstanding pop-ups before ending process 600. A step 644 ends process 600.

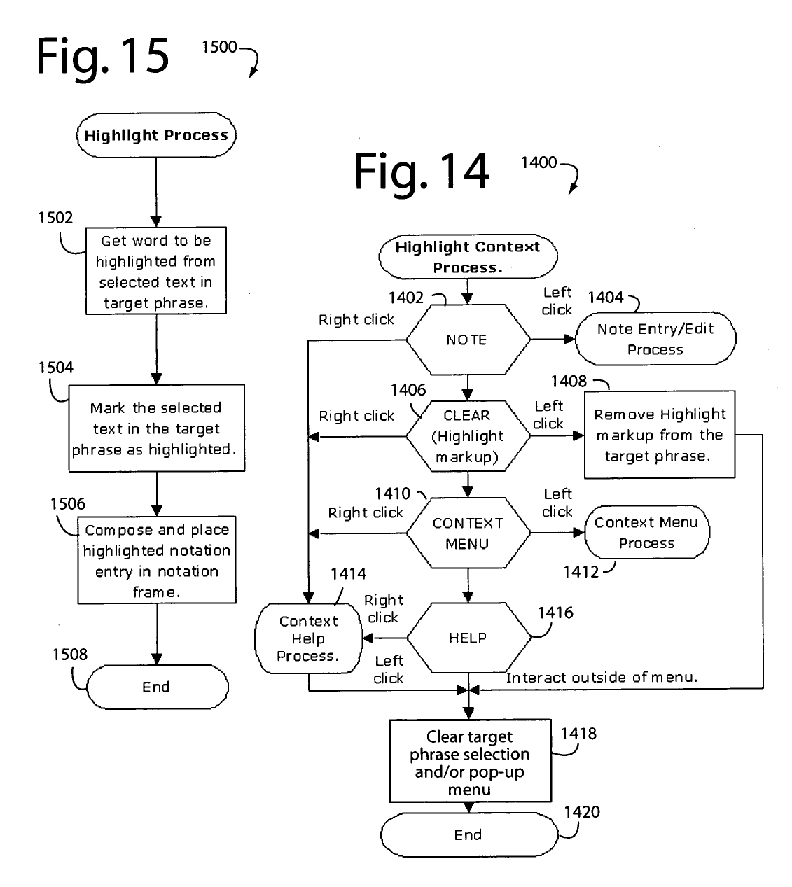

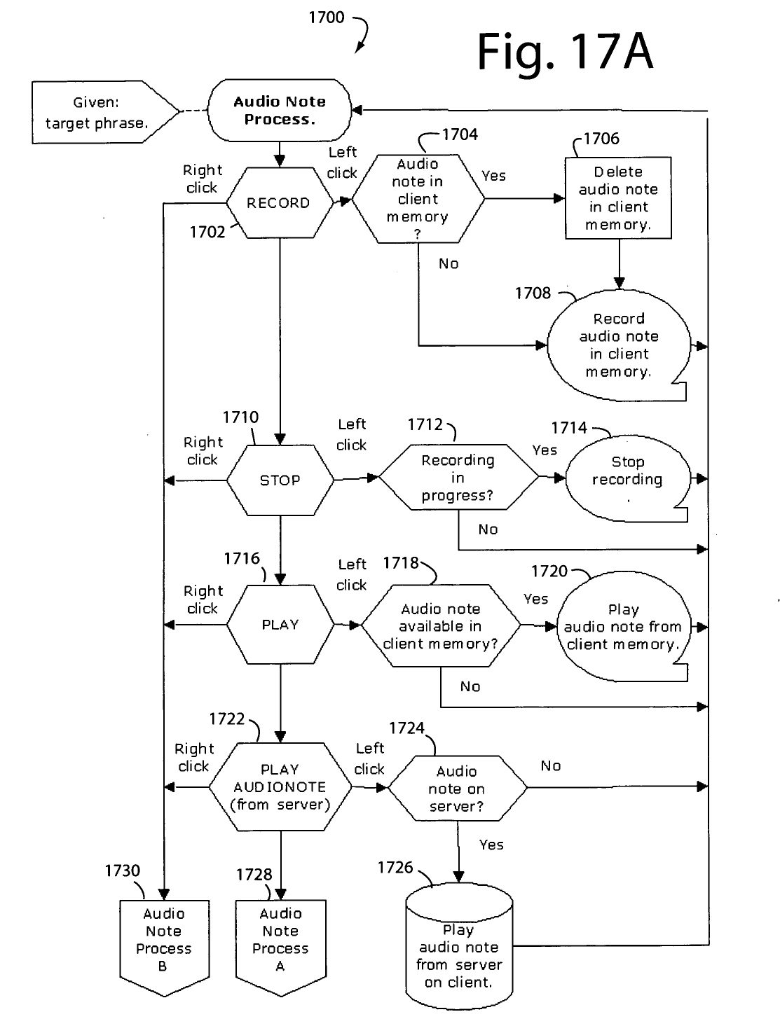

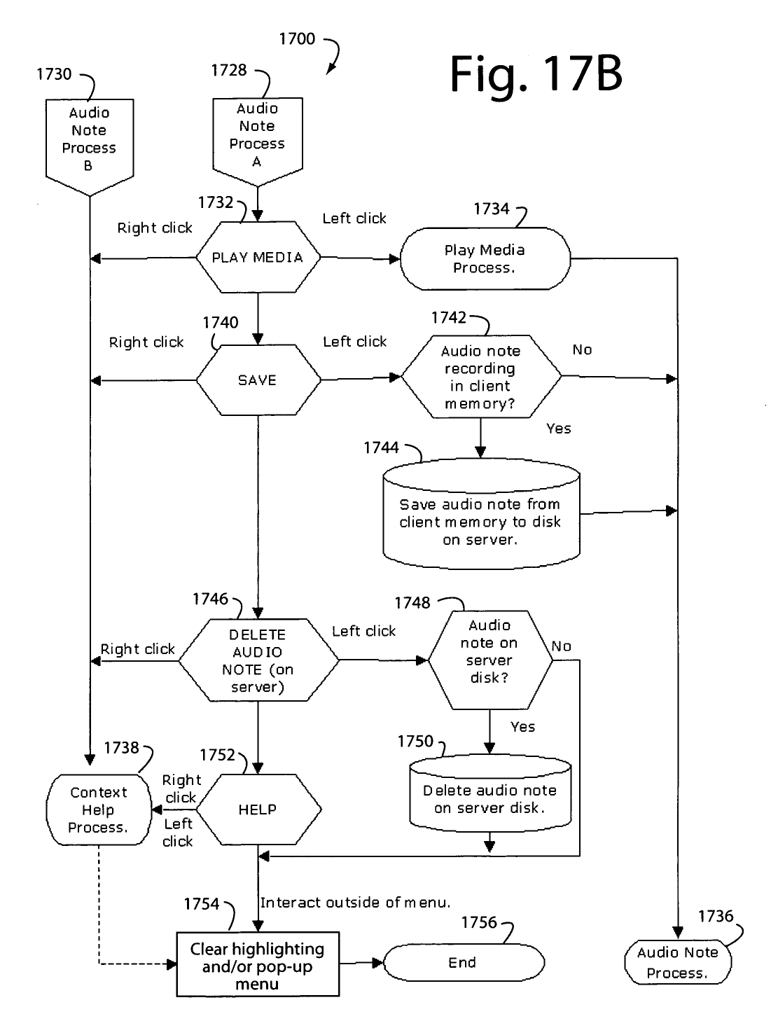

FIG. 7 represents a text selection process 700, (see step 510, FIG. 5). In a step 702, a user selects a text phrase. In a step 704, a right-click of the mouse is watched for. In a step 706, the target phrase is highlighted and a “selected text” pop-up menu is displayed. A step 708 looks for a left-click on a “lookup” menu item. If so, a lookup process 710 is called, see step 1704, FIG. 17. A step 712 looks for a left-click on a “highlight” menu item. If left-clicked, a highlight process 714 is called, see step 1500, FIG. 15. A step 716 looks for a left-click on a “context menu” menu item, see step 600, FIG. 6. If left-clicked, a context menu process 718 is called context menu process. Any click of a “help” menu item will be detected by a step 720 and a context help process 722 will be called. A step 724 clears any remaining highlighting and outstanding pop-ups before ending process 700. A step 726 ends process 700.

FIG. 8 represents a markup selection process 800, (see step 514, FIG. 5). A step 802 permits a user to select markup text phrases. A step 804 highlights the selected text in the users browser. A step 806 looks for a right-click in “lookup” markup. If right-clicked, then a lookup context process 808 is called, e.g., process 1700, FIG. 17. A step 810 looks for a right-click in “note” markup. If right-clicked, then a note entry/edit process 812 is called, e.g., process 1300, FIG. 13. A step 814 looks for a right-click in “highlight” markup. If right-clicked, then a highlight context process 816 is called, e.g., process 1500, FIG. 15. Right-clicking any text not marked up calls a return with an end step 818.

FIG. 9 represents a chapter heading selection process 900 (see step 518, FIG. 5). A step 902 highlights the chapter heading. A step 904 looks to see if a “save?” menu item has been left-clicked. If so, a step 906 saves the user's markup to the server. A step 908 looks to see if a “refresh” menu item has been left-clicked. If so, a step 910 prompts the user with a warning that all markup can be lost. A step 912 waits for a user response. If the user chooses to proceed, a step 914 reloads the subject text and user markup from before the last save. A step 916 looks to see if a “pause/resume” menu item has been left-clicked. If so, a pause/resume media process 918 is called, e.g., process 1826, FIG. 18. A step 920 looks to see if a “print” menu item has been left-clicked. If so, a step 922 prints the subject text with the user's markups. Any click of a “help” menu item will be detected by a step 924 and a context help process 926 will be called. A step 928 clears any remaining highlighting and outstanding pop-ups before ending with step 930.

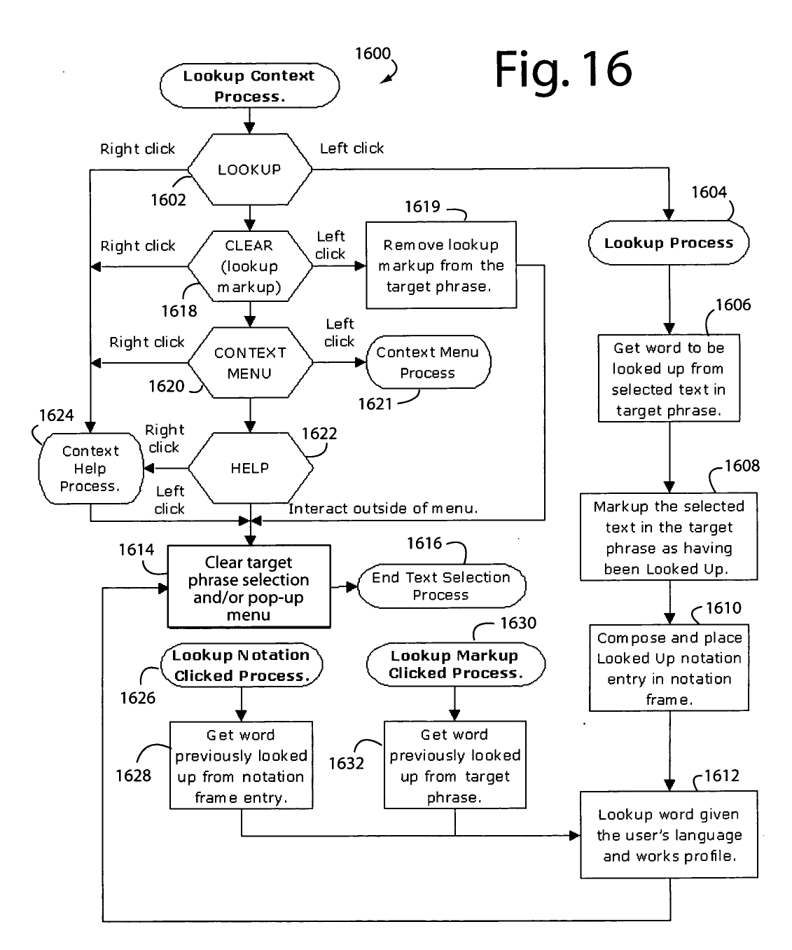

FIG. 10 represents a markup action process 1000 (see step 522, FIG. 5). A step 1002 allows a user to click on a markup in a subject frame. A step 1004 checks if this is an “audio note” markup. If so, a step 1006 plays such audio note. A step 1008 checks if this is an “lookup” markup. If so, a lookup markup-clicked process 1010 is called, e.g., process 1630, FIG. 16. A step 1012 ends process 1000.

FIG. 11 represents a notation action process 1100 (see step 526, FIG. 5). A step 1102 puts the phrase markup at the top of a subject frame. A step 1104 checks if this is an audio note notation. If it is, a step 1106 plays the audio note for the user. A step 1108 checks if this is a lookup notation. If it is, then a lookup notation clicked process 1110 is called, e.g., process 1626, FIG. 16. A step 1112 sees if this is a highlight notation. If so, a step 1114 skips to the end 1120. A step 1116 sees if this is a note notation. If so, a step 1114 skips to the end. A step 1118 sees if this is a bookmark notation. If so, a step 1114 skips to the end 1120. A step 1120 ends process 1100.

FIG. 12 represents a mouseover note markup process 1200 (see step 530, FIG. 5). A step 1202 allows the user to run the cursor across the note markup. A step 1204 displays the note text in a pop-up window. A step 1206 ends process 1200.

FIG. 13 represents a note entry/edit process 1300 (see step 1404, FIG. 14). A step 1302 issues a prompt dialog box with the current note. A step 1304 allows the user to enter/edit text notes in the prompt dialog box. A step 1306 sees if the user wants to submit the note. If yes, a step 1308 changes the highlighted text to note markup. A step 1310 associates the note with the markup. A step 1312 replaces the highlight or markup with note markup in the notation frame. A step 1314 clears the target phrase selection and the pop-up window. A step 1316 ends process 1300.

FIG. 14 represents a highlight context process 1400 (see step 816, FIG. 8). A step 1402 looks for a click of the mouse on a “note” menu item. If a left-click, a step 1404 calls a note entry/edit process, see process 1300, FIG. 13. A step 1406 looks for a click of the mouse on the “clear” menu item. If a left-click, a step 1408 removes the highlight markup from the target phrase. A step 1410 looks for a click of the mouse on a “context menu” menu item. If a left-click, a step 1412 calls a context unselected process (see process 600, FIG. 6). A step 1416 looks for any click of the mouse on a “help” menu item. If so, a context help process 1414 is called. A step 1418 clears the target selection and any pop-up menu. A step 1420 ends process 1400.

FIG. 15 represents a highlight process 1500 (see step 714, FIG. 7). A step 1502 fetches a word for highlighting from selected text in the target phrase. A step 1504 marks the selected text as highlighted. A step 1506 composes and places the highlighted notation entry in the notation frame. A step 1508 ends process 1500.

FIG. 16 represents a lookup context process 1600 (see step 808, FIG. 8). If the user left-clicks on a “lookup” menu item, a step 1602 detects this and calls a lookup process 1604 (see step 710, FIG. 7). A step 1606 gets the word to be looked up from the selected text in the target phrase. A step 1608 marks the selected text as looked up. A step 1610 composes and places the looked up notation in the notation frame. A step 1612 looks up the word with respect to the user's language and profile. A step 1614 clears the target phrase selection and pop-up menu. A step 1616 calls an end-text selection process. A step 1618 sees if the user left-clicks on a “clear” menu item. If so, a step 1619 removes the lookup markup from the target phrase. A step 1620 sees if the user left-clicks on a “context menu” menu item. If so, a step 1621 calls a context menu process (see process 1600, FIG. 16). A step 1622 looks for any click of the mouse on a “help” menu item. If so, a context help process 1624 is called. A lookup notation clicked process 1626 (see step 1110, FIG. 11) uses a step 1628 to get the word previously looked up from the notation frame entry. A lookup markup clicked process 1630 (see step 1010, FIG. 10) uses a step 1632 to get the word previously looked up from the target phrase.

FIG. 17A represents an audio note process 1700 (see step 614, FIG. 6). A target phrase is passed to process 1700. A step 1702 checks if the user left-clicks on a “record” menu item. If so, a step 1704 looks to see if an audio note is already in client memory. If yes, a step 1706 deletes the audio note in client memory before proceeding. A step 1708 records the audio note in client memory. A step 1710 checks if the user left-clicks on a “stop” menu item. If so, a step 1712 looks to see if a recording is in progress. If yes, a step 1714 stops the recording. A step 1716 checks if the user left-clicks on a “play” menu item. If so, a step 1718 looks to see if the audio note is available in client memory. If yes, a step 1720 plays the audio note. A step 1722 checks if the user left-clicks on a “play audio note (from server)” menu item. If so, a step 1724 looks to see if the audio note is available on the server. If yes, then a step 1726 plays the audio note from the server by copying it to the client where it can be played. A connector-A 1728, and a connector-B 1730 connect this flowchart to FIG. 17B.

FIG. 17B continues the description of process 1700 from FIG. 17A. Connector-A 1728 passes to a step 1732 that looks for a left-click on a “play media” menu item. If left-clicked, a play media process 1734 is called (see process 1900, FIG. 19). Then an audio note process 1736 is called, e.g., process 1700, FIG. 17A. Otherwise, if right-clicked, a context help process 1738 is called. If the user left-clicks on a “save” menu item, a step 1740 calls a step 1742 to decide if the audio note is in client memory. If not, the audio note process 1736 is called (see process 1700, FIG. 17A). Otherwise, a step 1744 saves the audio note from client memory to the database on the server, and continues to step 1736. Otherwise, if “delete audio” was right-clicked, the context help process 1738 is called. A step 1746 detects if the user left-clicks on a “delete audio note (on server)” menu item. If left-clicked, a step 1748 sees if the audio note is on the server. If yes, a step 1750 deletes the audio note on the server disk. Otherwise, if it was right-clicked, the context help process 1738 is called. A step 1752 looks for any click of the mouse on a “help” menu item. If so, the context help process 1738 is called. A step 1754 clears highlighting and any pop-up menu. A step 1756 ends process 1700.

FIG. 18 represents a play media process 1800 (see steps 606 and 610, FIG. 6). A target phrase is passed to the play media process 1800. A step 1802 locates the target phrase on audio or video media as the current position. A step 1804 highlights the target phrase. A step 1806 starts playing the target phrase. A step 1808 sees if the user wants to pause. If not, a step 1810 finishes playing the target media phrase. A step 1812 clears the highlighting. A step 1814 sees if the user clicks on a “play continue” menu item. If no, then a step 1816 sets an end mark at the current position. A step 1818 ends the process. Otherwise, if “play continue” was yes, then a step 1820 checks for the end of media. If the end is encountered, a step 1822 sets the position to the start, and the process ends. If not the media end, it loops back to repeat through a step 1824 which sets the next phrase as the target phrase. If in step 1808 the answer was yes to “pause?”, then a pause resume process 1826 is called. A step 1828 sees if the media is playing. If not, control passes to step 1804. If yes, a step 1830 clears the highlight from the text phrase corresponding to the current media position. A step 1832 sets the paused position as the current position. A step 1834 ends the process.

The present invention is not limited to the particular embodiments described here in detail. These are detailed flowcharts and functional block diagrams are included here to demonstrate the general construction and interoperation. Another way to gain more insight into the breadth and scope of the present invention is to understand how typical embodiments would interact with a user.

In an overview of operation of the described embodiment, each user is presented with a web page that uses a tab and button model for navigation to the various facilities. The greeting page is a Front Desk tab. The Welcome page is a current button. On an initial visit, the user completes an enrollment process. Afterwards, a setup help should be reviewed. Thereafter when the user returns, only a sign-in is required.

After sign-in, a Stacks tab is activated. If this is the first session, a Reading List page is opened to select the text to study. A Text page is opened to a selected text. If the user had already made a selection previously at the Reading List page, the Text page is opened to the place in the text where they were last. The Text page is divided into two parts, a text panel that contains the text select from a Reading List, and a notation panel which includes a summary of text markups.

Within the Text panel, the text is parsed into “punctuation” phrases. The user interacts with the phrases through context functions by right clicking a mouse on the phrase. During a reading of the selected text, the user can interact with the text. For example, by playing a video/audio recording and watching/listening to a native speaker read/act the phrase. The entire text is recorded and may be played out. After watching/listening to the native speaker, users can try reading the phrase in the subject language by making a short audio note. These audio notes are stored on the server, and the phrase is annotated with an audio note mark. The phrase can be translated to native language in a small pop-up window. Phrases can be bookmarked for future reference.

Users can interact with individual words or phrases within the “punctuation” phrases. Individual words may be automatically looked up in dictionaries on the Internet. Words or phrases may be highlighted. Notes may be attached to highlighted text, and then displayed in a small pop-up window automatically appearing with the note when the highlighted text is touched by the cursor. Later these notes may be edited or cleared.

The words researched in the dictionary, the highlighting, the notes, the audio notes, and the bookmarks that were made in the text can all be repeated for reference in the annotation panel on the Text page. Clicking the marked up text in the notation panel, the actual phrase is navigated to within the larger text. Notes and audio notes may be reviewed, and words may be re-researched. Extensive contextual help is available throughout the application.

The first thing that a new user does is enroll. In a prototype that was built, enrollment was done by a Front Desk tab just after the web page was launched, the Welcome page greets the user, and the new user must select the Enroll page by clicking the ENROLLMENT button. However, if the user was already enrolled then only a sign-in was required.

TABLE I
Enrollment Procedure

To enroll:
1. After clicking the ENROLLMENT key the enrollment

form appears in the Welcome page. The form must be filled
out completely then click the yellow ENROLL button at the
bottom of the welcome screen;

2. enter their new User Identification in the text

box;

3. compose a password in the Password text box;
4. re-enter their password in the Re-Enter Password

text box;

5. enter their email Address in the text box;
6. Select Native Language by clicking the arrow key,

then select the language with the cursor;

7. Select Language of Study in the same manner as

above; and

8. then clicking an ENROLL button.

If there were problems with the fields entered, the user was prompted to correct them. Otherwise the user was enrolled, a greeting message appeared. After the user closed the greeting message the user was automatically sent to a Setup Help page. This assisted the user in setting up their browser for operating with the prototype. After setting up their browser, the user was sent to the library Stacks, card Catalog page to select the text to study.

ActiveX is a Microsoft technology that permits increased scripting (programming) on web pages. The prototype used ActiveX technology extensively to provide features and functions to the user. Audio Notes are digital recordings that the user associates with the text. Although the audio notes facilities are quite useful, they are not essential, and could be added later.

XML DOM was used to store information related to their place in the text that the user was reading. It can remember where the user was in text when the user left. So when the user returns to the text the system can reopen to that spot.

Windows Media Player by Microsoft was used to download and play audio from the server. This permits the user to have a native speaker read phrases of text, or read text continuously. Such can also be used to support the playing of video media.

A Text screen was divided into two distinct panels. The panel on the left of the window was the notation/table of contents (TOC) panel and the larger one on the right was the text panel.

A notation/TOC panel was used to contain all of the notations that are made to the text panel in the reading process. Not all texts have a TOC, as an example, most short stories do not. The notation/TOC panel reflects operations in the text panel and includes the table of contents, words that have been looked up, highlighted text, note text, and bookmarks and phrases that have audio notes attached to them.

The text panel included text that the user selected in a Catalog subheading. Within the text panel, the selected text was displayed. The user scrolled through the text using the vertical and horizontal scroll bars. As in most scrollable content, the overall window size and the length of the text determined the scroll bar operation. Several functions were available in the text panel.

Chapter Header Functions could be accessed by right-clicking the Chapter Header (title) in the Stacks tab, Text page. “Save” stored the current audio notes and markup. These are automatically saved when the user terminates the session. The user could initiate the Save manually. “Refresh” completely erases all audio notes and markup from the text. “Pause/Resume” stops the Read Phrase, or Read Continuous. When clicked a second time the reading resumed.

Right-clicking the mouse while the cursor was on the subject phrase accessed these functions. When the mouse was right-clicked over the phrase, the phrase background was changed to light gray and a menu appeared to the right and below the cursor position. The menu items could be selected by positioning the cursor over the item and left-clicking the mouse.

“Read Phrase” background of the phrase was turned light pink when the audio of the native speaker reading the phrase was played. When the phrase was complete, the background was restored.

“Read Continuous” background of the phrase was turned light pink when the audio of the native speaker reading the phrase was played. When the phrase was complete, the background was restored. The background of the next phrase turned light pink and the audio of the native speaker reading the phrase was played, until the reading was paused (title context menu) or the last phrase was read. As each phrase was read, the text panel was repositioned so that the subject phrase was near the top of the window.

“Audio Notes” background of the phrase was turned light blue and the audio note menu appears below and to the right of the cursor position enabling the user to record an audio note that was associated with the subject phrase.

After an audio note was recorded, the audio note symbol appeared at the beginning of the phrase and an entry was made in the notation/TOC panel.

“Translate” background of the phrase was turned light yellow and a translation of the phrase in the native language of the user was displayed in a pop-up box with a black border and light yellow background.

A bookmark/symbol appeared at the beginning of the phrase and an entry was made in the notation/TOC panel.

Various utility functions operated on selected text. They were accessed by first selecting text, e.g., holding the left mouse button down while moving the cursor across the desired text. Such caused the background to change to dark blue. The left mouse button was released when all the desired text was selected. If the object of the selection was only one word it could be selected by double clicking the left mouse button over that word.

When holding the cursor in the selected text, and clicking the right mouse button, the phrase background was changed to light gray and a menu will appear to the right and below the cursor position. The menu items could be selected by positioning the cursor over the item and left-clicking the mouse.

“Lookup” caused the highlighted word to be passed to the selected dictionaries. If the word was found in the dictionary, the definition was displayed in the dictionary window. At the completion of the Lookup function, the selected word was highlighted in light green and an entry was made in the Notation/TOC frame.

For “Lookup Context”, if the user placed the cursor over the light green highlighted word and right-clicks, the lookup context menu appeared. The user could then choose to re-lookup the word or Clear it.

“Clear Lookup” allowed the user to select a Clear function, where the light green Lookup highlight was removed and the text restored to the original appearance. The entry in the Notation/TOC frame was removed.

For “Highlight Context” if the cursor was placed on the highlighted text and the user right-clicks, then the Highlight context menu appears. The user could select to make a Note or to Clear the highlighted area.

If a user-selected Note was to be associated with the highlighted text, a prompt was initiated that will permit entry of the user Note. When finished writing, the user clicked the OK button or (to abort) the Note Cancel button.

When a Note was complete the highlighting changed to a brighter light yellow. The user could display the Note simply by running the cursor over the highlighted area. Once the Note was complete, the Note context menu appeared if the cursor was placed on the highlighted text and right-clicked. The user could select to make an Edit Note or to Clear the Note. If the user chose Edit Note, a prompt was displayed enabling the editing of the Note text. On completion of the Note Edit, the user clicked an “OK” button or (to abort a Note) the Cancel button. If the user selected a Clear function, then such Note was removed and the text was restored to its original state.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A learning system, comprising:
a web server for communicating with browser web pages disposed on network clients;
a learning system application hosted on the web server and able to communicate with individual ones of said web pages; and
a database of collected subject text, reference text, and media related to the subject text, wherein the subject text is divided into portions, the reference text is divided into portions corresponding to the subject text portions, and the related media is coordinated by timing marks with respect to the subject text portions, the learning system application being configured to communicate with the database and the web pages such that if a user of one of the web pages selects one of the portions the user is enabled to play an associated portion of the related media and is enabled to display an associated portion of the reference text, and wherein the user is enabled to annotate the selected portion or make an audio recording associated with the selected portion such that the annotation and the audio recording becomes part of the database.

2. The teaming system of claim 1, wherein:
wherein the reference text is a multilingual dictionary.

3-8. (canceled)

9. The teaming system of claim 1, wherein the related media is an audio recording of a speaker reading the subject text.

10. The learning system of claim 1, wherein the related media is an audiovisual recording of a speaker reading the subject text.

11. The learning system of claim 1, wherein the related media comprises still images.

12. The learning system of claim 1, wherein the subject text is a foreign language subject text and the related media is a recording of a foreign language speaker reading the subject text.

13. The learning system of claim 12, wherein the reference text is a foreign language-to-a-native-language dictionary with regard to the subject text.

14. The learning system of claim 1, wherein the reference text is a mono-lingual dictionary.

15. The learning system of claim 1, wherein the reference text is a foreign language translation of the subject text, the learning system application being configured such that a reference to a given portion of the subject text provides a translation of the portion from the reference text.

16. A learning system, comprising:
a web server for communicating with browser web pages disposed on network clients;
a learning system application hosted on the web server and able to communicate with individual ones of the web pages such that each web page comprises a subject frame, a notation frame, a reference frame, and a media frame; and
a database of subject text, reference text, and media related to the subject text, wherein the wherein the subject text is divided into portions, the reference text is divided into portions corresponding to the subject text portions, and the related media is coordinated by timing marks with respect to the subject text portions, the learning system application being configured to communicate with the database and the web pages such that if a user of one of the web pages selects one of the portions displayed in a subject frame the user is enabled to play an associated portion of the media in the media frame and is enabled to display an associated portion of the reference text in the reference frame, and wherein the user is enabled to annotate the selected portion or record an audio associated with the selected portion within the notation frame such that the annotation and the audio recording becomes part of the database.

17. The learning system of claim 16, wherein the related media is an audio recording of a speaker reading the subject text.

18. The learning system of claim 16, wherein the related media is an audiovisual recording of a speaker reading the subject text.

19. The learning system of claim 16, wherein the related media comprises still images.

20. A learning method using a web server for communicating with browser web pages disposed on network clients; a learning system application hosted on the web server and able to communicate with individual ones of the web pages; and a database of collected subject text, reference text, and media related to the subject text, wherein the subject text is divided into portions, the reference text is divided into portions corresponding to the subject text portions, and the related media is coordinated by timing marks with respect to the subject text portions, the method comprising:
within one of the network clients:
displaying a portion of the subject text;
selecting the displayed portion of the subject text such that an associated portion of the media plays through the network client; and
annotating the selected portion with user-added text such that the user's added text becomes part of the database.

21. The method of claim 20, further comprising:
annotating the selected portion with a user-added audio recording such that the user's added audio recording becomes part of the database.
